(19) United States
(12) Patent Application Publication
(10) Pub. No.: US 2011/0166769 A1
(43) Pub. Date: Jul. 7, 2011

(54) Supplemental Vapor Fuel Injection System for Internal Combustion Engines

(76) Inventors: Jeffrey Douglas Buechler, Langley (CA); David Glen Shea, Abbotsford (CA)

(21) Appl. No.: 12/982,671

(22) Filed: Dec. 30, 2010

Related U.S. Application Data
(60) Provisional application No. 61/292,954, filed on Jan. 7, 2010.

(51) Int. Cl. F02D 19/02

(52) U.S. Cl. 701/103

(57) ABSTRACT

A supplemental vapor fuel injection system for internal combustion engines capable of utilizing numerous supplemental vapor type fuels such as propane, compressed natural gas (CNG), liquid natural gas (LNG), butane, ammonia, biogas, hydrogen, ammonia, and Hythane®. The system includes a vaporizer/pressure regulator that provides pressure regulated vapor fuel to two specially designed vapor fuel injectors and a controller unit capable of real-time control of the vapor fuel injectors. The injectors meter precise amounts of vapor fuel into a manifold that combines the vapor for delivery to a directional nozzle located in an airstream of the diesel engine.

This patent application claims the benefit of U.S. provisional application No. 61/292,954 filed Jan. 7, 2010. The disclosure of the provisional application is hereby incorporated herein by reference.

### TECHNICAL FIELD OF THE INVENTION

The present invention relates generally to fuel conversion systems and more particularly to a system for introducing a supplemental vapor fuel into an internal combustion engine.

### BACKGROUND OF THE INVENTION

A number of dual fuel conversion systems have been developed and sold over the years where generally a secondary alternative fuel, typically designed to operate using propane or natural gas, is introduced into the pre-turbocharged airstream of an internal combustion engine in order to provide greater fuel economy, reduce particulate emissions, and improve engine power. Examples of such systems are disclosed in U.S. Pat. No. 3,577,726; U.S. Pat. No. 7,006,155; and U.S. Pat. No. 7,100,582.

However a number of safety concerns arise from using these systems. Introducing a secondary vapor fuel upstream of a turbocharger allows vapor fuel to fill the entire intake system from point of vapor fuel ingress with a highly flammable fuel/air mixture. Fuel-charged air must pass through the turbocharger, which may act as an ignition source for the charged fuel-air mixture should the turbocharger fail.

Also, many of today's engines are equipped with intercoolers. The highly flammable fuel-charged air would fill the intercooler and, in the event of damage, a leak, or a front end collision, the fuel-charged air in the intercooler may easily ignite, leading to an explosion.

Furthermore, many on-road diesel engines utilize the pressurized air from the turbocharger to pre-charge an air compressor that operates the braking system, air ride seats, air horns and the power fifth wheel in many applications. The addition of vapor fuel into the charge air system pre-turbocharger would send a combustible mixture into the compressor and subsequently into all air operated systems on the vehicle or other equipment. Having a combustible air mixture going into a compressor, which can leak or fail, and then into the air brake system on a heavy piece of equipment is illegal and very dangerous. Additionally, having vapor charged air going into the cab of a truck to activate the air ride seat may also vent fuel-charged air into the driver compartment of the vehicle.

In addition, the response time of the amount of vapor fuel-charged air to actual engine demand is slow, due to a long path for the fuel-charged air to reach the engine. This also results in a greater than necessary quantity of fuel-charged air being consumed. When the throttle is quickly turned down/off there is a significant quantity of charged air still to enter the engine, and without the correct diesel fuel charge to utilize it, this can cause severe stresses on the engine leading to turbocharger explosion. Severe damage to the engine cylinders may also ensue due to extremely high cylinder pressure. Additionally, on engine shut down there is the possibility of fuel-charged air being left in the intake system, and this mixture may “bleed back” into the atmosphere causing a potential fire/explosion risk.

A safer, more efficient method for supplying a supplemental fuel to an internal combustion engine is to introduce the supplemental fuel post turbocharger. Davis (U.S. Pat. No. 5,408,978) describes a component for introducing a supplemental fuel into an airstream for induction into an internal combustion engine post turbocharger. It is mounted on a conduit between the turbocharger and the engine. However, no means of fuel control is described. It is essentially a simple valve apparatus.

There is therefore a need for a safer, more efficient and performance enhancing, complete supplemental fuel system for internal combustion engines.

### SUMMARY OF INVENTION

The present invention provides a safer, more efficient and performance enhancing, complete supplemental fuel system for internal combustion engines. The system is not only designed for post-turbocharger operation but also has the ability to utilize not only propane and natural gas but numerous other vapor and liquid alternative fuels including butane, ammonia, biogas, hydrogen, ammonia, and Hythane®. This fuel adaptability allows for the system to be used in a number of environments in which previous systems cannot operate. For example, propane and natural gas may not be used in certain mining and industrial work sites, whereas the system disclosed herein addresses this concern by offering a supplemental vapor fuel injection system that may use a broader range of fuels specifically suited to unique environments. More particularly, the system is designed to inject a supplemental charge of a vapor fuel such as but not limited to propane, compressed natural gas (CNG), liquid natural gas (LNG), butane, ammonia, biogas, hydrogen, ammonia, and Hythane® into internal combustion diesel engines to enhance performance, fuel economy and reduce exhaust emissions for both health and environmental benefits.

One aspect of the present invention is directed to a supplemental vapor fuel injection system for internal combustion engines which includes a source of supply of a supplemental fuel, a vaporizer/pressure regulator that is compensated to a load on a given internal combustion engine and operable to receive the supplemental fuel from the source of supply thereof and produce a regulated vapor fuel, a fuel injection control assembly connected in flow communication with a post-turbocharger airstream and with the regulator and operable to receive regulated vapor fuel from the regulator and to receive a stream of fuel injection pulses and inject the regulated vapor fuel into the post-turbocharger airstream in accordance with the stream of fuel injection pulses, a plurality of sensors operable to sense data in real time relating to operating characteristics of the given internal combustion engine, and a controller unit that stores and utilizes a program to generate said stream of fuel injection pulses that controls the injection of the regulated vapor fuel based on an engine manufacturer's specifications relating to the given internal combustion engine and real time sensor data received from said plurality of sensors.

Another aspect of the present invention is directed to a supplemental vapor fuel injection system for internal combustion engines which includes a source of supply of a supplemental fuel, a vaporizer/pressure regulator operable to receive the supplemental fuel from the source of supply thereof and produce a regulated vapor fuel, a vapor fuel injection nozzle directionally mounted in a predetermined relationship in an airstream of a given internal combustion engine, a manifold connected in flow communication with the vapor fuel injection nozzle, one or more vapor fuel injectors connected in flow communication with the manifold and the regulator and operable to receive the regulated vapor fuel from the regulator and to receive a stream of fuel injection pulses and to meter precise portions of the regulated fuel vapor for injection into the manifold and thereafter into the airstream of the given internal combustion engine by the directionally mounted vapor fuel injection nozzle, a plurality of sensors operable to sense data in real time relating to operating characteristics of the given internal combustion engine, and a controller unit including one or more microprocessors that store and utilize a program to generate the stream of fuel injection pulses that controls the injection of the regulated vapor fuel based on an engine manufacturer's specifications relating to the given internal combustion engine and the real time sensor data received from the plurality of sensors.

A further aspect of the present invention is directed to a supplemental vapor fuel injection system for internal combustion engines which includes a source of supply of a supplemental fuel, a vaporizer/pressure regulator that is compensated to a load on a given internal combustion engine and operable to receive the supplemental fuel from the source of supply thereof and produce a regulated vapor fuel, a fuel injection control assembly connected in flow communication with a post-turbocharger airstream and with the regulator and operable to receive regulated vapor fuel from the regulator and to receive a stream of fuel injection pulses and inject the regulated vapor fuel into the post-turbocharger airstream in accordance with the stream of fuel injection pulses, and a controller unit that stores and utilizes a program to generate the stream of fuel injection pulses that controls the injection of the regulated vapor fuel based on an engine manufacturer's specifications relating to the given internal combustion engine and real time data received by sensing of engine RPM, throttle position, supplemental vapor fuel pressure, supplemental vapor fuel temperature, engine coolant temperature, exhaust gas temperature, and supplemental fuel level to diagnose system parameters wherein the parameter values are monitored and actions are initiated in the event of one or more faults.

### BRIEF DESCRIPTION OF DRAWINGS

FIG. 1 is a schematic view of the components of the supplemental vapor fuel injection system of the invention, with diesel engine components being included for reference showing the interconnection of the invention.

FIG. 2a is a perspective drawing of a vapor injection nozzle employed by the system, showing the nozzle in a view parallel to the intake runner tube, specifically displaying the machined alignment surfaces of the nozzle.

FIG. 2b is an elevational view of a conventional mounting nut, used to secure the nozzle of FIG. 2a to the tube, the nut being shown for reference.

FIG. 3 is another perspective drawing of the vapor injection nozzle of FIG. 2a, showing the nozzle in a view perpendicular to the intake runner tube, specifically displaying the outlet ports of the nozzle.

FIG. 4 is a schematic illustration of the components of the controller unit in the control assembly of the system of FIG. 1.

FIG. 5 is a simplified schematic flow diagram of a fuel map calculation process and adjustments performed by the controller unit of FIGS. 1 and 4.

### DETAILED DESCRIPTION OF EMBODIMENTS

Overview

The present disclosure provides for a supplemental vapor fuel injection system for internal combustion engines capable of utilizing numerous vapor type fuels such as propane, natural gas, biogas, ammonia, hydrogen, methane, butane, and Hythane® as described herein. The system includes a combined vaporizer and pressure regulator unit (for sake of brevity hereinafter shortened to either “vaporizer/pressure regulator” or “vaporizer/regulator”) that provides regulated supplemental vapor fuel pressure to two specially designed vapor fuel injectors and a controller unit capable of real-time control of the vapor fuel injectors. The injectors meter precise amounts of vapor fuel into a specially designed manifold that combines the vapor for delivery to a directional nozzle located in the post-turbocharged airstream of the diesel engine. While a diesel engine is shown in the exemplary embodiment, any internal combustion engine may be adapted with minor alterations to the installation and adjustment procedures. Addition of supplemental vapor fuel has the ability to increase performance of the engine while reducing exhaust emissions, including particulate matter. Further, the supplemental vapor fuel reduces the consumption of the engine's base fuel supply therefore aiding in economy.

The vaporizer/regulator, specific to the fuel used, provides regulated vapor pressure to two specially designed vapor fuel injectors. A controller unit containing one or more microprocessors is programmed via an onboard USB or other interface from a laptop or other computer. With a few basic vehicle parameters, and operational preferences, an injection control map is automatically generated for the specific vehicle. This auto-programming feature drastically reduces installation setup time, yet allows custom tuning if required.

Turbocharger boost pressure, engine RPM, exhaust gas temperature, engine coolant temperature, supplemental vapor fuel pressure, supplemental vapor fuel temperature and throttle position are used to provide live data to the controller unit where the microprocessor(s) interpret the data along with the pre-programmed map to provide real-time control of the vapor fuel injectors.

The injectors meter precise amounts of vapor fuel into a specially designed manifold that combines the vapor fuel for delivery to a directional nozzle located in the post-turbocharged airstream of the diesel engine. Post-turbocharged injection removes the danger of vapor fuel being present in the entire intake air system as with pre-turbocharged installations and also allows more timely and precise fuel control.

Turbocharger boost pressure compensation is used to track the injected vapor pressure to changes in engine load ensuring stable vapor fuel supply volume under all operating conditions. Non-turbocharged applications may also be aided by this system, in which case throttle position alone replaces turbocharger boost pressure input, and vapor gas injection still remains close to the intake manifold for safety.

The microprocessor(s) continually monitor all sensor inputs to ensure data is within expected parameters. If the data falls outside the expected parameters it makes a determination on the severity of the fault. Serious faults, such as in the case of high exhaust gas temperatures or loss of vapor pressure, initiate a system safety shutdown; otherwise the fault is stored and continuously monitored for status. Safety shutdown faults fall into two categories, the first being non-recoverable in which service is required to correct the fault, and the second being recoverable where a temporary timed shutdown is initiated until the event causing the fault has passed.

An example of a non-recoverable fault would be a hardware or component failure. An example of a recoverable fault would be high exhaust gas temperature that is usually a limited time instance caused by driving conditions. The supplemental nature of this device allows normal diesel engine operation to be restored automatically during a system safety shutdown. All diagnostic faults are stored for retrieval by service personal while the driver is alerted to required service through a multifunction switch/fuel level gauge located on the vehicle dashboard.

In an exemplary embodiment, the supplemental fuel injection device is designed to inject a supplemental charge of a gaseous fuel such as propane or natural gas into the charge air system of a diesel engine. This supplemental gaseous fuel mixes with the intake charge air, displacing an equal density of charge air while converting the balance to a combustible mixture. This hybrid mixture causes three major effects on the combustion cycle of a diesel engine. The first effect is the enhancement of flame propagation in the diesel charge, causing more complete combustion earlier in the cycle and raising the apparent Cetane level of the diesel. The second effect is to reduce particulate matter as a result of more complete combustion early in the combustion cycle versus late combustion taking place partly into the exhaust stroke. The third major effect is increased energy generated as a result of the aforementioned combustion efficiency coupled with the increased cylinder pressure generated from the higher expansion rate of the gaseous fuel charge as compared to that of air. The increased energy output allows the same work to be done with a lower commanded volume of diesel.

Based on initial installer data input, the controller unit automatically calculates a fuel map for the specific engine. Various engine sensors including but not limited to RPM, turbocharger boost pressure, throttle position, exhaust gas temperature, supplemental vapor fuel temperature, and supplemental vapor fuel pressure interact with this map to deliver constantly updated fuel delivery in real time. To reduce any hazard of a fuel charge being present throughout the intake air system, all gas injection is provided post turbocharger. To accomplish this task a pressure compensated gas regulator is employed to deliver a constant differential pressure based on turbocharger boost. The entire system is monitored for faults by an onboard diagnostic system that is capable of providing a technician with a list of fault codes. As a repair tool, a built in diagnostic chart lists probable reasons for the fault along with suggested corrective measures. A series of engine run timers log the actual usage of the system in relation to normal engine run time. A mirrored set of timers and diagnostic code data is stored on board a microprocessor control unit for higher levels of interrogation of the system operation. Supplemental fuel usage may also be logged for performance analysis. Unique software activation protocols track the user and computer to the data entered or manipulated in the controller unit. This feature is useful in ensuring that only an authorized installer may adjust the system as well as allowing easy auditing by emission regulatory authorities to ensure compliance of the original installation.

Thus it may be seen that the total capabilities and function of this system far exceeds the sum of the functions of each of the individual elements of this or any previous systems.

### DETAILED DESCRIPTION

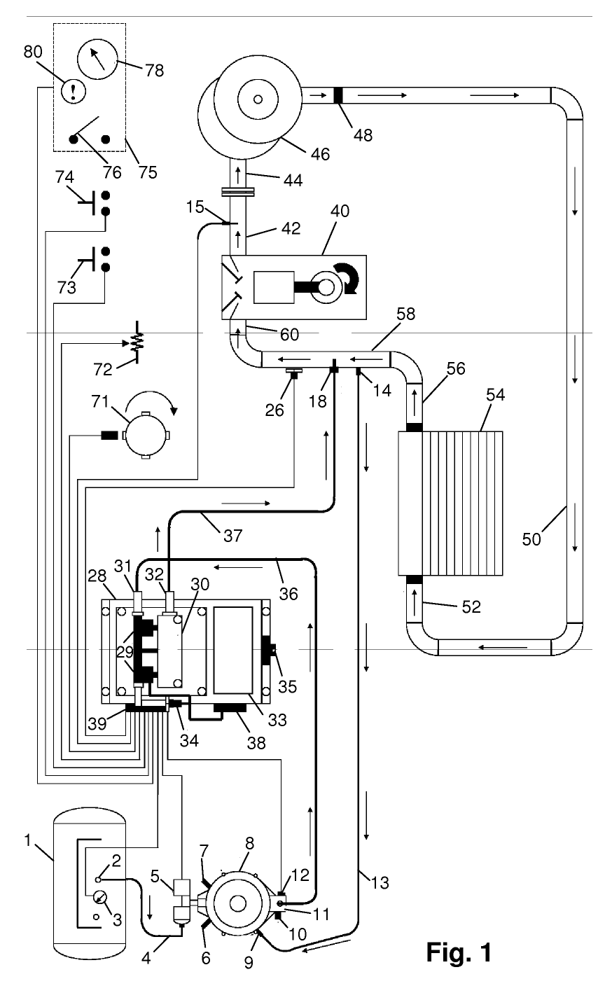

Referring to FIG. 1, there is illustrated an exemplary embodiment of a supplemental vapor fuel injection system in accordance with the present invention adapted for internal combustion engines, such as a standard diesel engine 40. A supplemental fuel pressure vessel 1 supplies the supplemental fuel for the system operation. The vessel style will vary depending on the type of supplemental fuel used. Fuels with low vapor pressures such as propane or ammonia will be stored as a liquid when compressed. Sufficient vapor pressure will normally exist to force the liquid from the tank without the need for any external pumps. Fuels with very high vapor pressures such as natural gas or hydrogen will traditionally be stored in a compressed gas form.

High-pressure fuel line 4, of appropriate type for the fuel used, carries the supplemental fuel from supplemental fuel pressure vessel 1 through fuel vessel outlet port 2 to fuel lock-off/filter assembly 5 which performs basic fuel filtering and also shuts down fuel flow when the system is normally inactive or performs a safety shutdown. A fuel level sensor 3 measures the amount of supplemental fuel in vessel 1. Note that the word “sensor” as used herein may be referred to elsewhere as a “sender”. Vaporizer/pressure regulator 8, specific to the fuel type used, converts either liquid fuel or high-pressure vapor fuel to a lower pressure, pressure regulated vapor. Engine coolant inlet port 6 and engine coolant outlet port 7 permit engine coolant flow that heats the vaporizer/regulator 8 to aid in liquid vaporization. Due to the refrigeration effect that occurs when liquid is vaporized, the coolant flow also reduces the chance of vaporizer/regulator “icing”. In the case of a high-pressure vapor fuel entering the vaporizer/regulator 8 such as in the case of natural gas or hydrogen, the coolant flow also reduces the refrigeration effect occurring when significant pressure drops occur through the natural pressure reduction/regulation of the vaporizer/regulator 8. Safety pressure relief valve 10 exists as a required safety device to vent excess supplemental vapor fuel pressure should a fault occur in vaporizer/regulator 8.

Fuel injection control assembly 28 includes vapor fuel injectors 29, vapor fuel injector manifold 30, vapor fuel inlet port 31, vapor outlet port 32 and supplemental vapor fuel pressure sensor 34. Controller unit 33 includes microprocessors 100, 102 (further described hereinafter) and USB port connector 35. Formats other than USB may be used for the connector 35. An electrical connector 38 is provided for electrically connecting the gas pressure sensor 34 and the injectors 29 to the controller unit 33.

Vapor fuel outlet port 11 supplies regulated vapor fuel through vapor fuel line 36 to vapor fuel inlet port 31. Vapor fuel injectors 29 use pulse width modulated signals from the controller unit 33 to alternately meter vapor fuel into vapor fuel injector manifold 30 that merges the vapor fuel from the two injectors 29 and passes it into vapor fuel outlet port 32. The alternate injection sequence distributes vapor fuel flow more equally over the engine cycle as well as reduces injector cycling, which in turn reduces wear. Even though two vapor fuel injectors 29 have been shown, only one or more than two may be used in alternate embodiments. The fuel injector manifold 30 may be a precisely machined billet aluminum block into which two vapor fuel injectors 29 are mounted using O-rings and press fitted so that they are rigidly mounted to the aluminum block to reduce vibration and aid in heat transfer, as well as acting as a solid mount for attaching the vapor fuel injectors 29 to the control assembly 28.

Vapor fuel outlet line 37 carries the metered vapor fuel to vapor fuel nozzle 18 that introduces the vapor fuel into the post-turbocharged airstream of diesel engine 40 generated from turbocharger 46. The vapor fuel outlet line 37 may be a hose of an appropriate length, for example, one that is typically 36″ long, and shorter if possible. Post-turbocharged airstream injection is inherently safer as it reduces the presence of vapor fuel throughout the entire intake air system as is common with pre-turbocharged injection systems.

In a standard diesel engine 40, exhaust gasses are routed through exhaust manifold 42 to turbocharger exhaust inlet port 44. Varying exhaust gas pressures, dependent on diesel engine 40 load conditions, drive turbocharger 46 to produce a positive pressure air charge from turbocharger charge air outlet port 48. The charge air is carried through turbocharger output charge air runner 50 to intercooler (if equipped) charge air inlet 52, through intercooler assembly 54, out through intercooler charge air outlet 56 and through diesel engine charge air inlet runner 58 to diesel engine intake manifold 60. The diesel fuel delivery system has been omitted as it is not affected, monitored or modified by this invention.

A turbocharger boost pressure compensation output port 14 on air inlet runner 58 supplies a sample of the boosted charge air, produced by turbocharger 46 and being carried by runner 58, to a turbocharger boost pressure compensation line 13 in which the charge air sample then travels through line 13 to a pressure compensation port 9 on vaporizer/regulator 8 for the purpose of turbocharger boost pressure compensation. Pressure compensation may be accomplished by applying turbocharger boost pressure to the top side of an internal diaphragm inside the vaporizer/regulator 8, which boosts (increases) the output of vaporizer/regulator 8 in a linear fashion such that the pressure of vapor fuel generated by the vaporizer/regulator 8 is higher than the turbocharger boost pressure. As an example only, the pressure of vapor fuel generated by the vaporizer/regulator 8 may be around 60 psi when turbocharger boost pressures are around 30 psi.

The vapor fuel output pressure for vaporizer/regulator 8 is raised in direct proportion to turbocharger boost pressure from turbocharger 46 to allow consistent fuel delivery with varying turbocharger boost conditions directly related to engine load. In other embodiments, vapor fuel output pressure may be raised according to another relation with turbocharger boost pressure, such as but not limited to proportional with an offset, non-linear, logarithmic, exponential, quadratic, step-function(s) or any combination of any number of these.

Turbocharger boost pressure sensor 26 electronically monitors boost pressure for use by controller unit 33 as a parameter to calculate vapor fuel control from vapor fuel injectors 29. Controller unit 33 uses software and/or firmware and/or hardware to monitor turbocharger boost pressures to perform system diagnostics.

Diesel engine RPM source 71 supplies an electronic pulse stream to controller unit 33 to indicate actual diesel engine operation as well as serves as a parameter to calculate vapor fuel control signals for vapor fuel injectors 29. Diesel engine RPM source 71 is connected to the control assembly 28 via connector 39. Connector 39, as well as other electrical connections to the control assembly 28, may be weatherproof, which allows the control assembly 28 to be mounted in a hostile environment such as an engine bay, rather than in a sheltered, dry location such as under the driver's seat or the dashboard.

Exhaust gas temperature probe 15 supplies data to controller unit 33 to monitor excessive exhaust gas temperatures and initiate a system shutdown and also cause delayed operation of the vapor fuel injection until sufficient combustion temperature is perceived through the exhaust gas temperature. A second probe (not shown) may be used in “V” configuration internal combustion engines. Controller unit 33 uses software, firmware and/or hardware to monitor exhaust gas temperatures to perform system diagnostics including sensor self test routines.

Throttle position sensor 72 provides a signal that controller unit 33 processes to control vapor gas injection during running conditions such as engine idle where operation of the system is desired. Specifically where naturally aspirated (non-turbocharged) applications occur, the microprocessors of the controller unit 33 may utilize throttle position in place of turbocharger boost to calculate engine demand. Controller unit 33 monitors the rate of change of throttle position sensor 72 to determine instantaneous rate of commanded acceleration and deceleration conditions. By supplementing additional vapor fuel during acceleration, exhaust emissions including visible particulate emissions may be further reduced, while enhancing engine response. Reduction of supplemental vapor fuel during deceleration will reduce unnecessary vapor fuel consumption.

Many cruise control systems on diesel engines fix the diesel fuel injection rate while reporting the commanded throttle position to be at an idle condition. Cruise control switch 74 may be used to indicate modes where this condition is present and allow controller unit 33 to discern the difference in states. Controller unit 33 includes the ability to allow supplemental vapor fuel delivery where throttle position sensor 72 may not indicate driver commanded throttle control. During cruise control operation, controller unit 33 samples and holds the current throttle position as an operational baseline. On naturally aspirated (non-turbocharged) engine applications, the sampled throttle position is used to calculate steady state vapor fuel injection during cruise controlled operation until such a time as the controller unit 33 detects a change in state of throttle position sensor 72.

Controller unit 33 uses the signal from brake light switch 73 and current throttle position sensor 72 data to detect deceleration. Controller unit 33 calculates the specific state of deceleration to determine appropriate conditions to shut down vapor fuel injection. From this process, conservation of the supplemental fuel supply is achieved during conditions where it is not required. Brake light switch 73 is also used to signal the end to cruise control operation.

Vaporizer temperature sensor 12 provides data to control assembly 28 to delay system operation until adequate coolant temperature exists to ensure sustained fuel vaporization. Controller unit 33 uses software to monitor vaporizer temperature to perform system diagnostics.

Supplemental vapor fuel pressure sensor 34, in fluid communication with the interior volume of injectors 29, monitors the vapor fuel pressure from vaporizer/regulator 8 to allow controller unit 33 to monitor system performance and perform diagnostics. Combined with a fuel level value from fuel vessel level sensor 3, controller unit 33 determines the appropriate fuel levels to initiate diagnostics.

Thus, in view of the foregoing, the controller unit 33 senses turbocharger boost, engine RPM, throttle position, supplemental vapor fuel pressure, supplemental vapor fuel temperature, engine coolant temperature, exhaust gas temperature, and supplemental fuel level to diagnose system parameters. Parameter values are monitored and appropriate actions are initiated depending on the severity of the fault, ranging from driver notification to system safety shutdown. The system design will not inhibit the normal engine operation when disabled. Additionally, all diagnostic data including all access incidents are logged in the controller unit 33. This feature allows for easy auditing by service personnel and emission regulatory authorities to ensure integrity and compliance of the original installation.

USB port connector 35 serves to interface controller unit 33 with a laptop or other computer. This port is available to allow initial programming of the controller unit 33 and provide live data and diagnostics during system service. This port also allows interrogation of system settings to confirm compliance with emission regulations. In an alternate embodiment, a wireless interface may be used instead of port connector 35.

Multi-function control/indicator assembly 75 is a self-contained unit that encompasses three functions. First, it includes an on/off switch 76 for driver control of the system operation. In situations where driver is not to be allowed to disable the system, such as with emission compliance regulations, this switch may be programmed to be constantly on making system operation completely automatic. Second, it includes a fuel level indicator 78 for the supplemental fuel vessel 1. Third, it includes a diagnostic indicator 80 controlled by controller unit 33, which alerts the driver to faults requiring service. Such faults are, but not limited to, injector open/short circuit detection, excessive exhaust gas temperature, exhaust gas temperature probe failure, regulated supplemental vapor fuel pressure faults, vaporizer operational temperature faults, turbocharger pressure compensation faults.

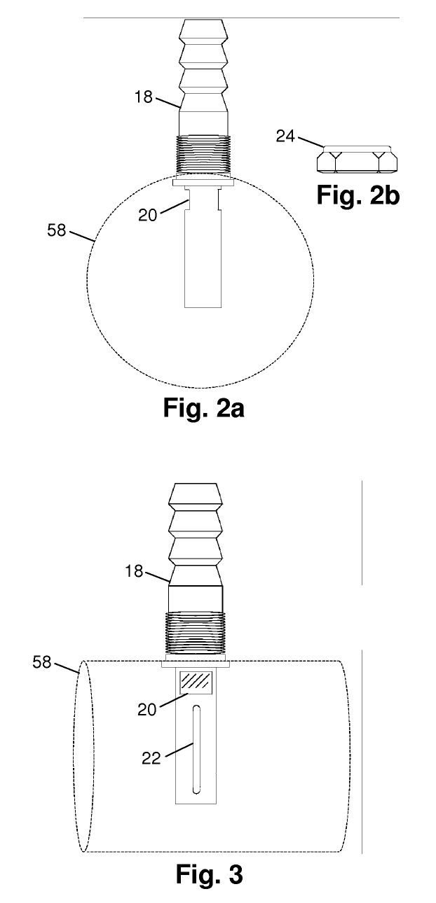

Referring to FIGS. 2a and 3 respectively, the vapor injection nozzle 18 is shown in views taken parallel and perpendicular to the charge air intake runner tube 58, specifically displaying the machined alignment surfaces 20. The two machined surfaces 20 allow for a 7/16″ wrench, held parallel to the intake runner, to provide proper alignment during installation. Vapor fuel nozzle 18 has two opposing vertical slots 22 to direct gas flow perpendicularly into the air stream thereby improving dispersal of the fuel vapor. This feature is important to proper dispersal of heavier fuels such as propane. The mounting nut 24 (a standard item) for the vapor injection nozzle 18 is shown in FIG. 2b for reference. Other dimensions may be used in other embodiments, and orientations other than perpendicular may be used in still further embodiments.

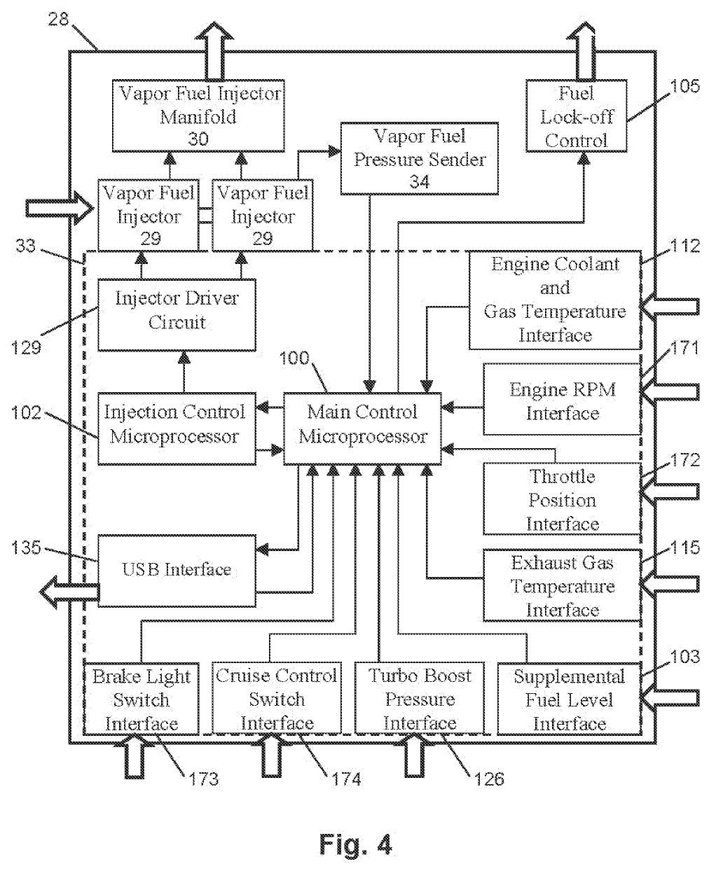

Referring to FIG. 4, an exemplary embodiment of the controller unit 33 of the supplemental fuel control system is shown in greater detail. The controller unit 33 controls real time supplemental vapor fuel injection based on a number of system parameters. Turbocharger boost pressure, engine RPM, exhaust gas temperature, engine coolant temperature, supplemental vapor fuel pressure, supplemental vapor fuel temperature, and throttle position are all used to provide live data to the controller unit 33 where its microprocessors then manipulate pre-programmed map data to provide real-time control of the vapor fuel injectors.

FIG. 4 shows the controller unit 33 mounted on the control assembly 28 and together with the vapor fuel injectors 29, the vapor fuel injector manifold 30 and the vapor fuel pressure sensor 34 of the control assembly 28. The controller unit 33 may comprise one or more microprocessors and one or more other control circuits and/or interface circuits. In the exemplary embodiment shown, a main microprocessor 100 communicates with various interface circuits and a dedicated microprocessor 102, which controls the injector drive circuit 129. The microprocessors 100, 102, may include memory in which is stored processor readable instructions forming a program, and in which is also stored processor readable data. Alternately, either or both the microprocessors 100, 102 may be connected to separate memory in which the computer readable instructions and data are stored. Data may include, for example, fuel mapping, sensor logging, expected parameter ranges, faults and/or passwords.

The main microprocessor 100 is connected to an engine coolant and gas temperature interface circuit 112, which takes an input from the vaporizer temperature sensor 12 on the fuel vaporizer/regulator 8. The temperature of the vaporizer is indicative of the temperature of the engine coolant. The main microprocessor 100 is also connected to a fuel lock-off control circuit 105 which in turn is connected to the fuel lock-off/filter assembly 5. The main microprocessor 100 is also connected to an engine RPM interface 171 that takes an input from the engine RPM source 71. The main microprocessor 100 is also connected to throttle position interface 172, which takes an input from the throttle position sensor 72. The main microprocessor 100 is also connected to exhaust gas temperature interface 115, which takes an input from exhaust gas temperature probe 15.

The main microprocessor 100 is also connected to supplemental fuel level interface 103, which takes its input from fuel vessel level sensor 3. The main microprocessor 100 is also connected to turbo boost pressure interface circuit 126, which takes its input from turbocharger boost pressure sensor 26. The main microprocessor 100 is also connected to cruise control switch interface 174, which takes its input from cruise control switch 74. The main microprocessor 100 is also connected to brake switch interface circuit 173, which takes its input from brake light switch 73. The main microprocessor 100 is also connected to USB interface 135, which is connected to USB port connector 35.

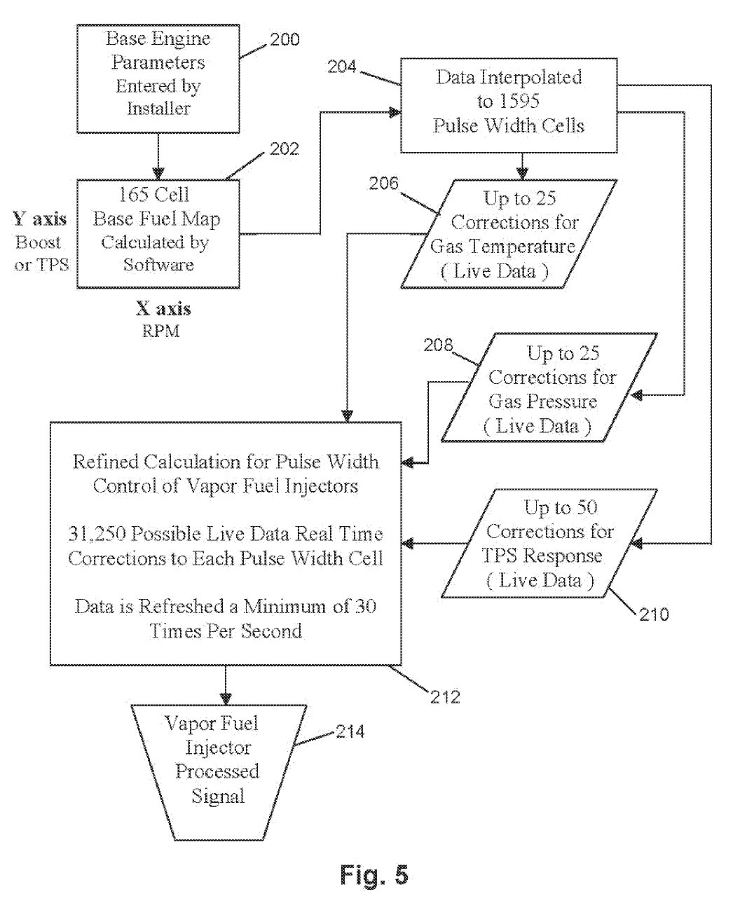

Referring to FIG. 5, there is shown a flow diagram of a process in which a fuel map is calculated and used to create vapor fuel injector signals via interaction with captured live data. After initial installation of the supplemental fuel injection system, the installer performs a series of simple programming steps to initialize the system. The initial engine specifications along with the supplemental fuel type are inputted 200 into the main microprocessor 100 of the controller unit 33 in the control assembly 28 via a laptop or other computer connected to the USB port connector 35 of the control assembly 28. These inputs include engine displacement, the number of engine cylinders, and operational preferences such as safety limits, desired emission functionality and sensor calibration. These initial parameters are used to generate 202 a load based fuel map for controlling the supplemental fuel delivery.

This base fuel map allows for 165 user adjustable cells. The map includes 15 values of engine RPM in 200 RPM increments from 600 RPM to 3400 RPM and 11 values of boost pressure in 5 PSI increments from 5 psi to 55 psi, generating a total of 165 cells. The cells are interpolated 204 by main microprocessor 100 to result in a rectangular array of 29×55=1,595 interpolated fuel injection pulse widths. The RPM values in the map are interpolated to 100 RPM intervals, resulting in 29 values, and the pressure values in the map are interpolated to 1 psi intervals, including interpolation from 0 psi, to result in 55 pressure values.

The data from this map is further manipulated in real time by the controller unit 33 using engine data inputs including 206 up to 25 corrections for the supplemental vapor fuel temperature as measured by vaporizer temperature sensor 12; including 208 up to 25 corrections for supplemental vapor fuel pressure as measured by vapor fuel pressure sensor 34 (which corrects for fuel density changes); and also includes 210 up to 50 corrections for magnitude change of throttle position as detected by throttle position sensor 72. These corrections are combined to result 212 in 25×25×50=31,250 possible combinations of corrections to the fuel injection pulse width. By multiplying the number of corrections by the number of interpolated points, this allows up to 49,843,750 possible values for the vapor fuel injection signal based on the entire fuel map. In the case of non-turbocharged applications it allows up to 25×25×1595=996,875 possible corrections based on the entire fuel map. The live data is captured and corrective calculations may be performed a minimum of 30 times per second. This allows for very timely and precise fuel control. Note that in other embodiments, fewer or greater than 30 corrective calculations per second may be made. Note also that in other embodiments, different numbers of cells and/or interpolation points and/or corrections may be used.

In turbocharged engine applications the turbocharger boost pressure along with engine RPM are used to select one of the 165 base cells. While in the case of non-turbocharged applications, the throttle position and engine RPM are utilized in a similar manner.

In addition to monitoring live data for calculation of injection pulse widths the microprocessors in controller unit 33 continually monitor all sensor inputs to ensure data is within expected parameters. If the data falls outside the expected parameters it makes a determination on the severity of the fault and takes appropriate action. Serious faults initiate a system safety shutdown, such as in the case of high exhaust gas temperatures or loss of supplemental vapor fuel pressure; otherwise the fault is stored and continuously monitored for status. Safety shutdown faults fall into two categories, the first being non-recoverable in which service is required to correct the fault, and the second being recoverable where only a temporary timed shutdown is initiated until the event causing the fault has passed.

The described supplemental vapor fuel injection system is applicable to many standard platforms such as ships, boats, cars, trucks, forklifts, off-road equipment and stand alone generators and pumps. Installation of the system is very similar to that shown in FIG. 1, with the possibility of a reduction in sensors that may not be required for off-road or stand alone equipment, as features such as cruise control or brake sensing may not be necessary.

We claim:

1. A supplemental vapor fuel injection system for internal combustion engines, comprising:
a source of supply of a supplemental fuel;
a vaporizer/pressure regulator that is compensated to a load on a given internal combustion engine and operable to receive said supplemental fuel from said source of supply thereof and produce a regulated vapor fuel;
a fuel injection control assembly connected in flow communication with a post-turbocharger airstream and with said regulator and operable to receive regulated vapor fuel from said regulator and to receive a stream of fuel injection pulses and inject the regulated vapor fuel into the post-turbocharger airstream in accordance with said stream of fuel injection pulses;
a plurality of sensors operable to sense data in real time relating to operating characteristics of the given internal combustion engine; and
a controller unit that stores and utilizes a program to generate said stream of fuel injection pulses that controls the injection of the regulated vapor fuel based on an engine manufacturer's specifications relating to the given internal combustion engine and real time sensor data received from said plurality of sensors.

2. The system of claim 1 wherein said supplemental fuel is one of propane, natural gas, biogas, ammonia, hydrogen, methane, butane or Hythane®.

3. The system of claim 1 wherein said real time sensor data includes turbocharger boost pressure and engine RPM.

4. The system of claim 1 wherein said real time sensor data includes any combination of one or more of supplemental vapor fuel temperature, supplemental vapor fuel pressure, throttle position, magnitude change of throttle position, engine coolant temperature, exhaust gas temperature, cruise control state and brake light state.

5. The system of claim 1 wherein said engine manufacturer's specifications include engine displacement and number of engine cylinders.

6. The system of claim 5 wherein said controller unit by utilizing said program generates an injection control fuel map based on supplemental fuel type and said engine manufacturer's specifications.

7. The system of claim 6 wherein said engine manufacturer's specifications are inputted to said controller unit via a computer.

8. The system of claim 6 wherein said program uses a combination of said real time sensor data including supplemental vapor fuel temperature, supplemental vapor fuel pressure, and magnitude change of throttle position to manipulate said control map to provide a multiplicity of possible combinations of corrections to widths of said fuel injection pulses in said stream thereof.

9. The system of claim 1 wherein said regulator is compensated to engine load by receiving a sample of charge air through a turbocharger boost pressure compensating line connected between an engine charge air inlet runner and said regulator.

10. The system of claim 1 wherein said fuel injection control assembly via a directionally mounted vapor fuel injection nozzle injects the regulated vapor fuel perpendicularly to said turbocharged airstream.

11. A supplemental vapor fuel injection system for internal combustion engines, comprising:
a source of supply of a supplemental fuel;
a vaporizer/pressure regulator operable to receive said supplemental fuel from said source of supply thereof and produce a regulated vapor fuel;
a vapor fuel injection nozzle directionally mounted in a predetermined relationship in an airstream of a given internal combustion engine;
a manifold connected in flow communication with said vapor fuel injection nozzle;
one or more vapor fuel injectors connected in flow communication with said manifold and said regulator and operable to receive the regulated vapor fuel from said regulator and to receive a stream of fuel injection pulses and to meter precise portions of the regulated fuel vapor for injection into said manifold and thereafter into the airstream of the given internal combustion engine by said directionally mounted vapor fuel injection nozzle;
a plurality of sensors operable to sense data in real time relating to operating characteristics of the given internal combustion engine; and
a controller unit including one or more microprocessors that store and utilize a program to generate said stream of fuel injection pulses that controls the injection of the regulated vapor fuel based on an engine manufacturer's specifications relating to the given internal combustion engine and said real time sensor data received from said plurality of sensors.

12. The system of claim 11 wherein said supplemental fuel is one of propane, natural gas, biogas, ammonia, hydrogen, methane, butane or Hythane®.

13. The system of claim 11 wherein said real time sensor data includes throttle position, engine RPM, and any of a combination of supplemental vapor fuel temperature, supplemental vapor fuel pressure, magnitude change of throttle position, engine coolant temperature, exhaust gas temperature, cruise control state, and brake light state.

14. The system of claim 11 wherein said engine manufacturer's specifications include engine displacement and number of engine cylinders.

15. The system of claim 14 wherein said controller unit by utilizing said program generates an injection control fuel map based on supplemental fuel type and said engine manufacturer's specifications.

16. The system of claim 15 wherein said engine manufacturer's specifications are inputted to said controller unit via a computer.

17. The system of claim 15 wherein said program uses a combination of said real time sensor data including supplemental vapor fuel temperature, supplemental vapor fuel pressure, and magnitude change of throttle position to manipulate said control map to provide a multiplicity of possible combinations of corrections to widths of said fuel injection pulses in said stream thereof.

18. A supplemental vapor fuel injection system for internal combustion engines, comprising:
a source of supply of a supplemental fuel;
a vaporizer/pressure regulator that is compensated to a load on a given internal combustion engine and operable to receive said supplemental fuel from said source of supply thereof and produce a regulated vapor fuel;
a fuel injection control assembly connected in flow communication with a post-turbocharger airstream and with said regulator and operable to receive regulated vapor fuel from said regulator and to receive a stream of fuel injection pulses and inject the regulated vapor fuel into the post-turbocharger airstream in accordance with said stream of fuel injection pulses; and
a controller unit that stores and utilizes a program to generate said stream of fuel injection pulses that controls the injection of the regulated vapor fuel based on an engine manufacturer's specifications relating to the given internal combustion engine and real time data received by sensing of engine RPM, throttle position, supplemental vapor fuel pressure, supplemental vapor fuel temperature, engine coolant temperature, exhaust gas temperature, and supplemental fuel level to diagnose system parameters wherein the parameter values are monitored and actions are initiated in the event of one or more faults.

19. The system of claim 18 wherein said actions range from driver notification and logging of said one or more faults to supplemental vapor fuel injection system safety shutdown such that normal engine operation will not be inhibited.

20. The system of claim 18 wherein said exhaust gas temperature is monitored using one or more exhaust gas temperature inputs.
